(19) United States
(12) Patent Application Publication
(10) Pub. No.: US 2013/0329043 A1
(43) Pub. Date: Dec. 12, 2013

(54) TRANSMISSIONS OF IMAGES IN A REMOTE RECOGNITION SYSTEM

(71) Applicants: BOAZ J. SUPER, WESTCHESTER, IL (US); THIBAUT DAVID, ESSONE (FR); MIKLOS STERN, WOODMERE, NY (US); BRUNO VANDE VYVRE, WESTHAMPTON, NY (US)

(72) Inventors: BOAZ J. SUPER, WESTCHESTER, IL (US); THIBAUT DAVID, ESSONE (FR); MIKLOS STERN, WOODMERE, NY (US); BRUNO VANDE VYVRE, WESTHAMPTON, NY (US)

(73) Assignee: MOTOROLA SOLUTIONS, INC., Schaumburg, IL (US)

(21) Appl. No.: 13/493,212

(22) Filed: Jun. 11, 2012

(51) Int. Cl. H04N 7/18; G06K 9/00

(52) U.S. Cl. 348/143; 382/103; 348/E07.085

(57) ABSTRACT

A method and apparatus for selective transmission of color information to a remote recognition system is provided herein. During operation, a central server may determine that at least one region in an image is ambiguously recognized, or unrecognized. In response, the central server will send a request for the image/video to be provided in color, or alternatively for a portion of the image/video to be provided in color. Because only selective images, or portions of images will be transmitted in color, the above transmission scheme enables reduction of bandwidth, and hence cost, required for transmitting images to the analytics server, without compromising the accuracy of the analytics.

### FIELD OF THE INVENTION

The present invention generally relates to transmission of images in a remote recognition system, and more particularly to selective transmission of color information to a remote recognition system.

### BACKGROUND OF THE INVENTION

Maintaining an understanding of current inventory is an important aspect of retail sales operations. Accordingly, various inventory-taking systems and processes have been employed, over the years, to assist retail store personnel in determining accurate estimates of current inventory. These systems and processes have included manual counting processes and handheld scanner based systems (e.g. barcode scanner systems and, more recently, systems that employ RFID technology), as well as vision-recognition systems. Manual counting processes are time consuming and prone to human error. When compared with manual counting processes and handheld scanner based systems, vision recognition systems have produced significant gains in efficiency and accuracy.

In vision-based inventory analysis system, cameras are generally placed throughout the premises, and periodic images are taken of store shelves. In a variation, images may be taken by a person using a portable camera or device containing a camera. In either case, these images are typically transmitted to a central server for analysis. When the central server is located off of the premises, the transmission of image data may take place over a cellular wireless networks.

In such networks, bandwidth is a significant cost of operating the service. Reducing that cost would increase the competitiveness and/or margin of any vision-based inventory analysis system. Therefore a need exists for transmission of images in a remote recognition system that reduces operating costs.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a top view of a simplified depiction of vision-based inventory analysis system deployed in a controlled area, in accordance with an example embodiment;

FIG. 2 is a side view of the system of FIG. 1 along line 2-2, in accordance with an example embodiment;

FIG. 3 is a simplified block diagram of a system coupled with an external system, in accordance with an example embodiment;

FIG. 4 illustrated communications between the systems of FIG. 4;

FIG. 5 is a flow chart showing operation of vision-based inventory analysis system of FIG. 3; and

FIG. 6 is a flow chart showing operation of the external system of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for selective transmission of color information to a remote recognition system is provided herein. During operation, a server may determine that at least one region in an image is ambiguously recognized, or unrecognized. In response, the server will send a request for the image/video to be provided in color, or alternatively for a portion of the image/video to be provided in color. Because only selective images, or portions of images will be transmitted in color, the above transmission scheme enables reduction of bandwidth, and hence cost, required for transmitting images to the analytics server, without compromising the accuracy of the analytics.

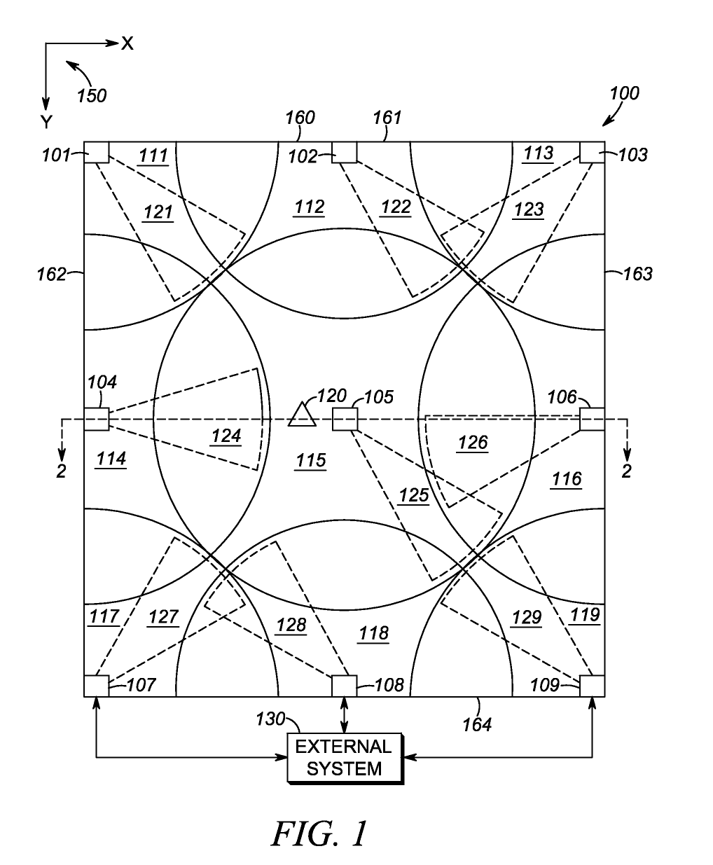

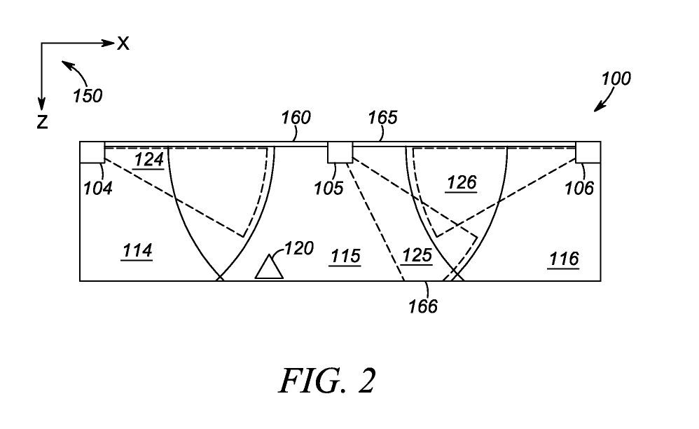

FIG. 1 is a top view of a simplified depiction of vision-based inventory analysis system 100 deployed in a controlled area 160, in accordance with an example embodiment. FIG. 1 should be viewed in conjunction with FIG. 2, which is a side view of the vision-based inventory analysis system 100 of FIG. 1 along line 2-2, in accordance with an example embodiment. System 100 includes a plurality of cameras 101, 102, 103, 104, 105, 106, 107, 108, 109 deployed in a controlled area 160, one or more products 120, and an external system 130 (sometimes referred to as a central server 130) communicatively coupled with the plurality of cameras 101-109. It should be noted that although external system 130 is shown as a central server, system 130 may comprise a distributed server system or cloud server. Although nine cameras 101-109 are illustrated in FIG. 1, the number of cameras 101-109 may be any integer number, N, where N may be from 1 to potentially hundreds of cameras 101-109. In addition, although only one product 120 is illustrated in FIG. 1, the number of products 120 may be any integer number, M, where M may be from 1 to potentially thousands of products 120. It should be noted that product 120 may be stand-alone, or may exist on store shelves (not shown).

The controlled area 160 may be defined, for example, by one or more walls 161, 162, 163, 164 (FIG. 1), a ceiling 165 (FIG. 2), and a floor 166 (FIG. 2), although the controlled area 160 need not be so defined. Cameras 101-109 are positioned in fixed locations throughout the controlled area 160. For example, as indicated in FIG. 2, cameras 101-109 are affixed to the ceiling 165 of the controlled area 110. However, this is not a necessity. In other example configurations, a camera may be handheld, affixed to the floor, to a wall, to a shelf, to a post, or to any other point with visibility into a controlled area. Further, although a controlled area 160 having a substantially rectangular shape is depicted in FIG. 1, and the cameras 101-109 are shown to provide complete coverage of the controlled area 160, embodiments of the inventive subject matter may be used in any size or shape of controlled area 160, and/or the controlled area may not be bound by walls, and/or the cameras may be deployed so that only partial coverage of the controlled area is established.

Each camera 101-109 is configured to acquire an image or video of any products 120 that are located within a field of view associated with the camera 101-109 (e.g. field of views 111, 112, 113, 114, 115, 116, 117, 118, 119), and to transmit the image or video 120 to external system 130.

According to an embodiment, in order to provide for dynamic adjustment of the orientation of each camera 101-109, each camera 101-109 may be configured to change the physical orientation of its field of view with respect to a fixed coordinate system 150. Although coordinate system 150 is shown in two dimensions (xy), one of ordinary skill in the art will recognize that the described system would easily be deployed in a three-dimensional area resulting in camera orientation including both pan and tilt. This results in adjustments to an angular orientation of each camera 101-109 with respect to a three-dimensional coordinate system. This enables a product 120 located anywhere within the premises to be detected, despite the narrowness of any particular camera's field of view. For example, although product 120 is not shown to be within the detection field of view 125 of camera 105 in either FIG. 1 or FIG. 2, a drive system associated with camera 105 may rotate the camera, and thus the field of view 125, to include the location of product 120, thus enabling detection of product 120.

According to an embodiment, system 100 supports various types of communications between external system 130 and cameras 101-109: control signals from external system 130 to cameras 101-109, as mentioned above; and the image or video from cameras 101-109 to external system 130. As will be described in more detail later, the camera control information may include polling parameters, such as the times, frequencies, and/or durations of polling operations to be performed by the cameras 101-109. Additionally, the camera control information may comprise a request for an image to be provided in color, or for a portion of an image to be provided in color. Additional communications between the external system 130 and cameras 101-109 may be supported by system 100, for example, cameras 101-109 may send status information to external system 130.

In addition, the polling parameters may include polling camera selections and polling camera activation durations, among other things. The control signals from external system 130 to cameras 101-109 also may include signals that dynamically control the orientation adjustment mechanisms of each of the cameras 101-109. More specifically, the external system 130 may provide signals to an orientation adjustment mechanism to which a camera 101-109 is affixed, in order to change the angular orientation of the detection field of view with respect to fixed coordinate system 150. In an embodiment in which a camera also is coupled to each orientation adjustment mechanism, additional control signals from external system 130 may control when the camera actively captures images, the zoom level for image capture, and other controllable settings relating to image capture.

The image or video sent from the cameras 101-109 to the external system 130 comprises visual representations of products 120. The image or video enables the external system 130 to establish or maintain knowledge of all detectable products 120 that are within the controlled area 160.

External system 130 may be, for example, an inventory monitoring system, a security system, or any of a variety of systems that may benefit from vision-based technologies employed in the various embodiments. For purposes of example, the remainder of the description below describes the external system 130 as being an inventory monitoring system. However, the description of an embodiment in which external system 130 is an inventory monitoring system should not be construed as limiting the scope of the inventive subject matter to a system that includes an inventory monitoring system. Instead, various types of external systems 130 (e.g., a planogram compliance system) may be used in conjunction with the various embodiments.

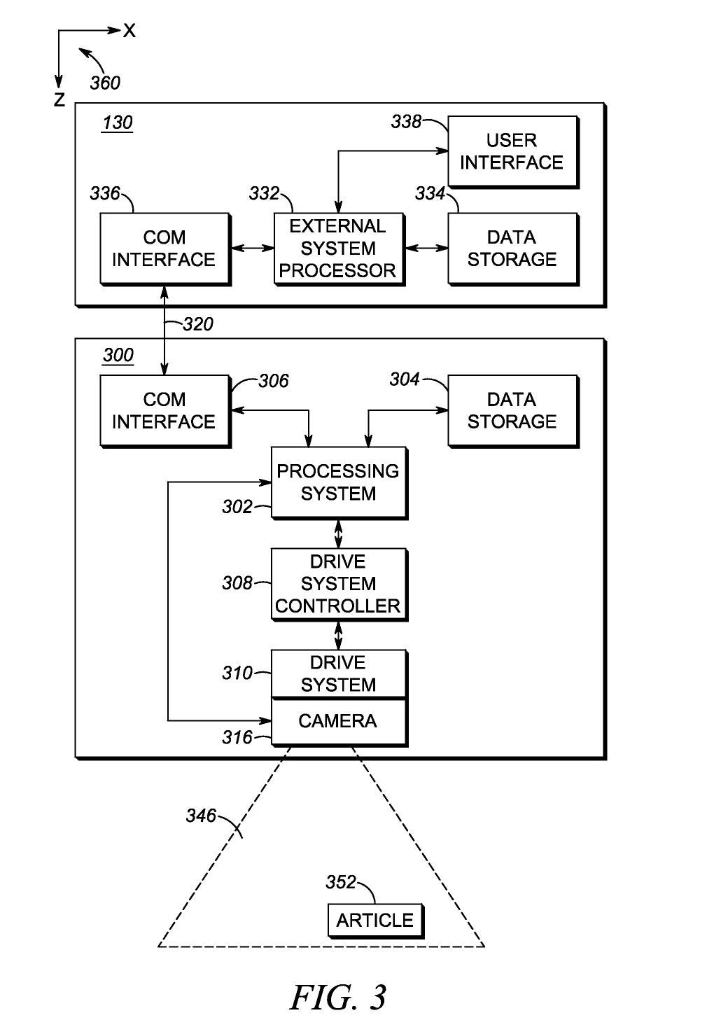

FIG. 3 is a simplified block diagram of a premise equipment 300 coupled with a central server 130, in accordance with an example embodiment. It should be noted that premise equipment may comprise “customer” premise equipment located within a store selling article 352, however, in alternate embodiments “premise” may refer to such locations as a warehouse, a depot, distribution center, archival facility, or any other facility housing article 352.

For purposes that will be discussed in more detail later, premise equipment 300 and central server 130 exchange various data and control signals through link 320 via communications (COM) interfaces 306, 336, respectively. Communications interfaces 306, 336 may be wired or wireless (i.e., RF) interfaces, which may implement any of a number of communications protocols.

Premise equipment 300 includes processing system 302, data storage 304, communications interface 306, at least one camera 316. As will be described in more detail later, processing system 302 comprises a microprocessor that is configured to coordinate the operations of the camera and the orientation adjustment mechanism based on control signals received from an central server 130 via communications interface 306. In addition, processing system 302 is configured to coordinate transmission of various types of data to the central server 130 via the communications interface 306, where the data may include one or more types of data such as, but not limited to angular orientation data (from the orientation adjustment mechanism), image data (from camera 316), image capture settings, log files, and status indications

Camera 316 is configured to capture still or video images within a field of view 346, and to produce image data corresponding to the images. Camera 316 may report the image data to the central server 130 via processing system 302 and communications interface 306, in an embodiment. Camera 316 may have a zoom capability (i.e. the ability to provide image data with increased resolution within a narrower portion of the field of view 346) that is controllable based on control signals received from processing system 302.

The orientation adjustment mechanism includes at least one drive system controller 308 and at least one drive system 310, in an embodiment. The drive system 310 includes one or more controllable servomotors, which control the physical position of an attachment structure (not shown). More specifically, the drive system 310 may cause the attachment structure to be rotated, with respect to a fixed coordinate system 360, about one, two, or three axes, in order to dynamically move the attachment structure in a desired manner or to position the attachment structure in a desired static position.

According to an embodiment, camera 316 also is physically and rigidly coupled to the drive system 310 (or more specifically, the attachment structure) so that the physical orientation of camera 316 may be adjusted. Adjustments to the physical orientation of camera 316 result in adjustments to the angular orientation of the field of view 346 of camera 316 with respect to the fixed coordinate system 360. When camera 316 has a zoom capability, the combination of the drive system 310 and the camera 316 may be considered to comprise portions of a pan-tilt-zoom (PTZ) camera system.

As indicated above, the drive system controller 308 is communicatively coupled with the drive system 310, and is configured to provide control signals to the drive system 310 that cause the drive system 310 to change the physical orientations of camera 316 (and thus field of view 346) and camera 316 (and thus field of view 346) with respect to the fixed coordinate system 360. Drive system 310 and/or drive system controller 308 are configured to produce angular orientation data indicating the angular orientation of the camera 316 (and thus field of view 346) and camera 316 with respect to the fixed coordinate system 360.

Processing system 302 receives the image data from camera 316, and the angular orientation data from drive system 310 or drive system controller 308, in an embodiment. Some or all of this information may be stored, at least temporarily, in data storage 304. Processing system 302 may then transmit some or all of the received information to central server 130 (via communications interface 306) in a manner that enables central server 130 to correlate the information in time. For example, processing system 302 may timestamp each type of information prior to storage and/or transmission. For example, processing system 302 may form a data packet (for transmission) with such temporally proximate information. In an alternate embodiment, one or more of camera controller 312, drive system controller 308, and camera 316 may timestamp its own information and send the information to central server 130 via communications interface 306 directly (e.g. without processing system 302 intervening). Either way, the ability of central server 130 to correlate the various types of information produced by premise equipment 300 enables the system 300 to be used for a number of advantageous purposes.

As indicated above, communications interface 306 of premise equipment 300 is an external system interface, which is configured to communicate image data, and angular orientation data to central server 130. In a system that includes one or more additional cameras (e.g. the system of FIGS. 1 and 2), central server 130 is configured to receive image data, and angular orientation data from the additional vision-based inventory analysis systems, as well.

Central server 130 includes external system processor 332, data storage 334, communications interface 336, and user interface 338, in an embodiment. Although central server 130 may be any of a variety of types of systems (e.g. an inventory monitoring system, a security system, and so on), an example of the functionality of central server 130 as an inventory monitoring system is discussed below for purposes of illustrating an example embodiment.

External system processor 332 includes one or more general or special purpose processors and associated memory and other circuitry, which is configured to enable external system processor 332 to provide control signals (via communications interface 336) to premise equipment 300. The various control signals provided by external system processor 332 may include, for example, signals that control the timing and duration of polling operations (i.e. operations performed by the camera to attempt to products), signals that control activation and operation of camera 316 (e.g. focus, lighting, zoom settings, and so on), signals that cause the drive system controller 308 to move the camera 316 and camera 316 to certain positions, and signals that cause the drive system controller 308 to move the camera 316 and camera 316 through various pan and tilt ranges (at controllable rates), and signals that cause a particular camera to provide an image, or a portion of an image in color.

In addition, external system processor 332 is configured to process image data, and angular orientation data received from premise equipment 300 (via communications interface 336). For example, when central server 130 is an inventory monitoring system, external system processor 332 is configured to maintain inventory information (e.g. in data storage 334) regarding quantities of a plurality of articles that are present within a controlled area (e.g. controlled area 160, FIG. 1) based on the image or video received from premise equipment 300. More specifically, in response to receiving an image or video from premise equipment 300 (and possibly the transaction status of the associated article), external system processor 332 may update the inventory information regarding quantities of the article present in the controlled area, in an embodiment.

In addition, because video or image information may be correlated with angular orientation data, external system processor 332 may be capable of determining specific physical locations of various articles. For example, in an embodiment, the location of premise equipment 300 within a controlled area is known by external system processor 332, along with the installation orientation of the premise equipment 300 (i.e. the fixed orientation of attachment of the premise equipment 300 within the controlled area with respect to the fixed coordinate system 360). In order to determine a location within the controlled area of a particular image/video that has been acquired by the premise equipment 300, geometrical analysis is performed using the angular orientation data for the image/video and the known physical location of the premise equipment 300 to determine, at least, a direction in which camera 316 was pointing at the time when the image/video was detected by the premise equipment 300. The determined direction may be correlated with a particular location within the controlled area.

In this particular embodiment, external system processor 332 serves to analyze image data received from system 300 and use image-recognition algorithms to identify particular products within images/video received. The particular products identified, and their locations may be used as part of inventory control in order to identify missing products.

User interface 338, which is communicatively coupled with the external system processor 332, is configured to provide inventory-related information (e.g. representations of inventory) to a human user, and to initiate and/or alter the execution of various processes that may be performed by the premise equipment 300. For example, user interface 338 may be configured to provide a graphical user interface (GUI), which enables a user to view lists or other representations of identified products that have been detected by processor 332. In an embodiment in which central server 130 is an inventory monitoring system, for example, user interface 338 may be configured to provide representation of current inventory (e.g. quantities of articles in inventory, locations of articles in inventory, and so on) in pictorial and/or textual forms. After an inventory has been established, user interface 338 may be manipulated by the user to convey (e.g. display) inventory information to the user. The inventory information may be conveyed in any of a number of formats, including lists, reports, spreadsheets, and graphical depictions. For example, inventory information may be displayed to the user as a planogram, which provides information about the location of products within the controlled area, including the locations of desired or misplaced articles. For articles that are misplaced, the user interface 338 additionally may display the correct locations for those articles, which enables store personnel to efficiently organize inventory in a desired way.

In addition, user interface 338 may enable the user to initiate a polling or inventory taking process, and/or to establish or modify parameters relating to polling or inventory taking processes. These parameters may include, for example, times, frequencies, and/or durations of polling operations to be performed by the camera of premise equipment 300, pan/tilt rates and ranges to be implemented by drive system controller 308 and drive system 310, control parameters for camera 316 (e.g. zoom settings and whether or not camera 316 is active or inactive during the polling operations), and data capture settings, among other things.

In order to provide the above features (and additional features), user interface 338 may include a computer, a monitor, a keyboard, a touch screen, a mouse, a printer, and various other hardware components to provide a man/machine interface. In an embodiment, user interface 338 and external system processor 332 may include distinct hardware components. In such an embodiment, user interface 338 may be co-located or remotely-located from external system processor 332, and accordingly user interface 338 may be operably connected with external system processor 332 via wired, wireless, direct, or networked connections. In an alternate embodiment, user interface 338 and external system processor 332 may utilize some shared hardware components (e.g. processors, memory, and so on).

As discussed above, in vision-based inventory analysis systems, bandwidth is a significant cost of operating the service. Reducing that cost would increase the competitiveness and/or margin of any vision-based inventory analysis system. In order to address this issue, processing system 302 will convert all images/video received from cameras to grey-scale images/video. Grey-scale image/video data will then be transmitted over link 320 via communications (COM) interfaces 306, 336.

External system processor 332 will utilize algorithms that operate on gray-scale images, so bandwidth can be saved by transmitting gray-scale images instead of the original color images. In one example, the jpeg-coded gray-scale image of a real-world retail image required 16.4% fewer bits than the jpeg-coded color image.

Although grey-scale images are suitable for identifying many products, there are cases in which the color of a sub-region of an image is needed by the algorithms. For example, where a primary difference in packaging of two products is a color of the packages, color information may be required to identify a particular product. When this is the case, external system processor 332 will request color information. The request for color information may comprise a message sent from com interface 336 to com interface 306 using a particular bit to indicate whether or not the image is to be transmitted in color or grey-scale. Of course information such as camera identification, orientation angle, zoom may be included in the message as well. In order to further reduce bandwidth, the message may comprise an indication of a portion of an image/video to be sent in color. For example, three bits may be utilized to identify a quadrant of an image to be sent in color. As an example, 001 may be utilized to transmit the lower right quadrant in color, 010 may be utilized to transmit the lower left quadrant in color, 011 may be utilized to transmit a center portion of the image/video in color, . . . etc. For another example, the algorithms may identify a region in which color information is requested, and the request may include a representation of that region. For example, if the region is a rectangle, the representation may include the coordinates of the top-left corner, the width, and the height. The region may be simple, such as a polygon, or it may be complex, with an irregular boundary, a non-convex boundary, or multiple disconnected subregions.

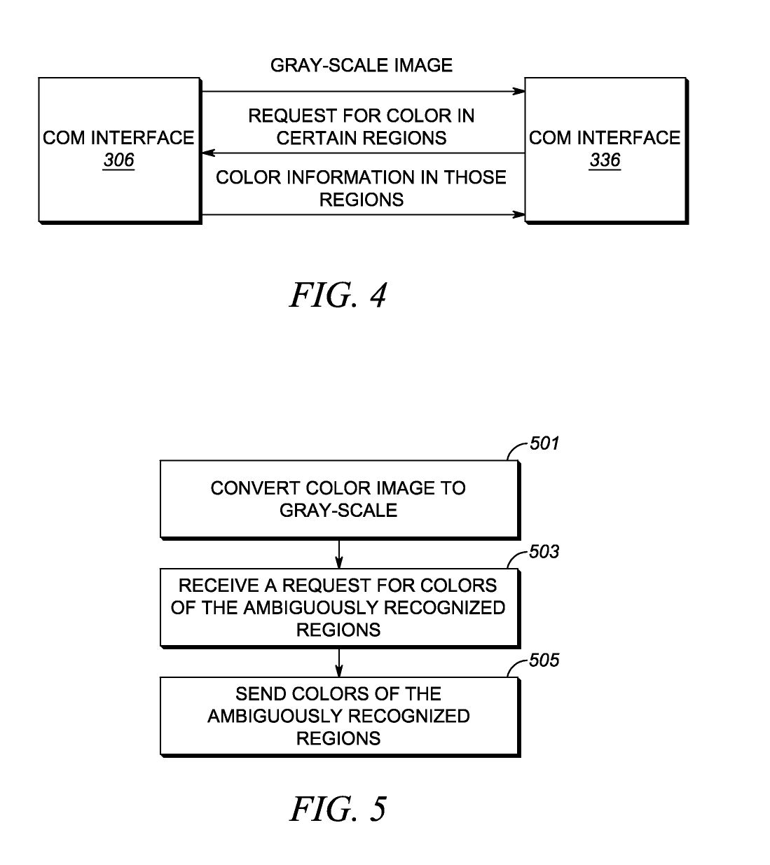

The above process can be illustrated in FIG. 4. As shown, com interface 306 provides a grey-scale image to com interface 336. A request is then received by com interface 306 from com interface 336. The request is for color to be provided for an image. In response, com interface 306 provides the image with color information. Alternatively, the request may be for colors to be provided for a portion of an image. In response, com interface 306 provides color information within the requested portion. The color information may take the form of, for example, a cropped color image or a list of pixel indices or coordinates with color values, and may be losslessly compressed, lossy compressed, or uncompressed.

FIG. 5 is a flow chart showing operation of system 300. The logic flow begins at step 501 where processing system 302 receives an image/video from camera 316 and converts the color image/video to grey-scale. At step 503 processing system 302 receives a request from com interface 336 to provide an image/video in color. As described above, the request may comprise a camera identification, an orientation for the camera, and a region of image/video that is to be provided in color. The logic flow continues to step 503 where the appropriate image/video is provided to comm. interface 336, and ultimately to central server 130.

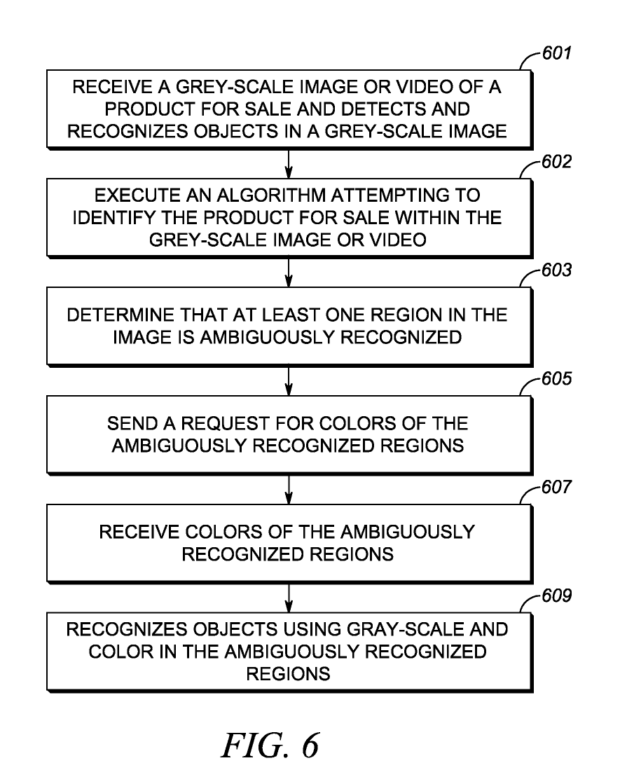

FIG. 6 is a flow chart showing operation of central server 130. The logic flow begins at step 601 where processor 332 receives a grey-scale image or video of a product (e.g., a product for sale) and detects and recognizes objects in a grey-scale image. At step 602 processor 332 executes an algorithm attempting to identify the product for sale within the grey-scale image or video. At step 603, processor 332 determines that at least one region in the image is ambiguously recognized, or unrecognized after running the algorithm. In response, at step 605, processor 332 sends a request for the image/video to be provided in color, or alternatively for a portion of the image/video to be provided in color, where the portion may include a region which is ambiguously recognized or unrecognized. At step 607 the requested image/video is received and at step 609, objects are recognized by processor 332 using an algorithm on the color (and possible grey-scale) image.

It should be noted that the request may be for another image/video of the same region to be provided, or, if system 300 stored the image/video, the request may be for the same image/video to be re-provided, only this time having at least a portion of the image/video provided in color. Additionally, the step of receiving the grey-scale image and the subsequent “color” image is preferably accomplished by receiving the images wirelessly over a cellular network. The premise equipment may comprise a camera. Finally, the identified product can be used in creating a planogram of the customer premises.

In the foregoing specification, specific embodiments have been described. However, one of ordinary skill in the art appreciates that various modifications and changes can be made without departing from the scope of the invention as set forth in the claims below. For example, the term “grey-scale” was used to describe an image with reduced color information. One of ordinary skill in the art will recognize that a “blue scale” or “red scale” or any “reduced-color scale” may be equally utilized as images with reduced color information. It is intended that the term “grey-scale” be representative of reduced color information images in general, including, for example, intensity images, without regard to how they are coded. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for requesting selective transmission of color information from premise equipment, the method comprising the steps of:
receiving a grey-scale image or video of a product;
executing an algorithm attempting to identify the product within the grey-scale image or video;
determining that the algorithm ambiguously recognized, or did not recognize a product within the image or video;
requesting the premise equipment to retransmit the image or video of the product having color;
executing an algorithm attempting to identify the product within the color image or video.

2. The method of claim 1 wherein the request is for a portion of the grey-scale image to be provided in color.

3. The method of claim 1 wherein the step of receiving the grey-scale image comprises the step of receiving the grey-scale image over a cellular network.

4. The method of claim 1 wherein the premise equipment comprises a camera.

5. The method of claim 1 further comprising the step of:
using an identified product in creating a planogram of the customer premises.

6. The method of claim 1 wherein the step of receiving comprises the step of receiving from the premise equipment.

7. The method of claim 1 wherein the product comprises a product for sale.

8. An apparatus comprising:
a communications interface receiving a grey-scale image or video of a product;
a processor executing an algorithm attempting to identify the product within the grey-scale image or video, determining that the algorithm ambiguously recognized, or did not recognize a product within the image or video;
the communications interface requesting the premise equipment to retransmit the image or video of the product having color; and
the processor executing an algorithm attempting to identify the product within the color image or video.

9. The apparatus of claim 8 wherein the request is for a portion of the grey-scale image to be provided in color.

10. The apparatus of claim 8 wherein the step of receiving the grey-scale image comprises the step of receiving the grey-scale image over a cellular network.

11. The apparatus of claim 8 wherein the premise equipment comprises a camera.

12. The apparatus of claim 8 further comprising the step of:
using an identified product in creating a planogram of the customer premises.

13. The apparatus of claim 8 wherein the step of receiving comprises the step of receiving from the premise equipment.

14. The apparatus of claim 8 wherein the product comprises a product for sale.

15. A method for requesting selective transmission of color information from camera, the method comprising the steps of:
receiving a grey-scale image or video of a product for sale from a camera;
executing an algorithm attempting to identify the product for sale within the grey-scale image or video;
determining that the algorithm ambiguously recognized, or did not recognize a product for sale within the image or video;
requesting the camera to retransmit the image or video of the product for sale having a portion of the grey-scale image in color;
executing an algorithm attempting to identify the product for sale within the color image or video; and
using an identified product for sale in creating a planogram of the customer premises.
